(19) United States
(12) Patent Application Publication
(10) Pub. No.: US 2024/0026915 A1
(43) Pub. Date: Jan. 25, 2024

(54) Assembly for Providing a Fastening Possibility for a Vehicle Component

(71) Applicant: Illinois Tool Works Inc., Glenview, IL (US)

(72) Inventor: Marek KUKUCZKA, Istebna (PL)

(21) Appl. No.: 18/222,811

(22) Filed: Jul. 17, 2023

(30) Foreign Application Priority Data
Jul. 22, 2022 (DE) 10 2022 118 408.0

(51) Int. Cl. F16B 21/06; B60R 13/02

(52) U.S. Cl. CPC F16B 21/065; B60R 13/0206

(57) ABSTRACT

The disclosure relates to an assembly (1) for providing a fastening possibility for a vehicle component (2), in particular an interior component, to a body component, where the assembly (1) is in particular designed as a torsion clip. The fastening assembly (1) includes a connecting element (3), preferably made of a plastic material, to which the vehicle component (2) is connectable. The fastening assembly (1) further includes a retaining element (4), preferably made of a plastic material, for retaining the connecting element (3) on the body component, According to the disclosure, it is provided in particular that the retaining element (4) includes a base body (5) with a retaining region (7) at a first end region of the base body (5), and the connecting element (3) includes a base body (6) with a receptacle opening (11) in which the retaining element (4) can be received at least in some areas, or through which the retaining element (4) and in particular the retaining region (7) of the retaining element (4) can be inserted at least in some areas in the insertion direction, where, for the purposes of assembling the assembly, the retaining element (4) can be rotated in relation to the connecting element (3), and where, when the retaining element (4) is rotated in relation to the connecting element (3), a force, in particular a linear force, that acts on the retaining element (4) is generated, so that the retaining element (4) is tensioned against the connecting element (3).

### RELATED APPLICATION

The present application claims the benefit of German Patent Application No. 10 2022 118 408.0, filed Jul. 22, 2022, the contents of which are hereby incorporated by reference.

### BACKGROUND

The present disclosure relates generally to a fastening possibility for fastening a vehicle component, in particular an interior component of a vehicle, to a body component. The vehicle component is in particular a vehicle grab handle or an airbag assembly.

Vehicle grab handles are provided in passenger cars, trucks, and sports cars for the purpose of providing support to occupants upon entering and exiting the vehicle. Vehicle grab handles can be static or dynamic. Dynamic grab handles can be moved between an extended position and a retracted position. Static grab handles, on the other hand, are fixedly attached, for example to the headliner of a vehicle. Typically, vehicle grab handles are supplied parts, which are then mounted to a vehicle body in the simplest possible manner.

A wide variety of designs for vehicle grab handles are known. Currently available vehicle grab handles can be attached to the roof through the headliner or can be attached to one of the roof support pillars, which are known as the A, B, or C-pillar, either directly or via a trim part. The A-pillar is the roof support pillar located between the windshield and the window of the first row of seats. The B-pillar is the roof support pillar between the front and rear door or, in a coupe, the pillar which is located behind the doors of the vehicle. The C-pillar is the roof support pillar located between the rear door and the taillight of the vehicle.

The mounting/fastening of vehicle grab handles is usually carried out by means of a snap-in process. For this purpose, at least one fastening clip of the vehicle grab handle is commonly inserted into a provided fastening opening of a vehicle body component and fastened there. It is customary to cover the region of the fastening opening with cover caps or similar covers, so that it is no longer visible from the inside of the vehicle. The vehicle grab handles or the handle pieces belonging to the vehicle grab handles can be arranged in handle recesses provided for this purpose, so that a substantially flush surface is obtained and the handle piece of the vehicle grab handle can nevertheless be grabbed comfortably.

To fasten a vehicle grab handle to a vehicle body component, it is known, for example from patent publication EP1084908A2, to insert a screw through an opening of the grab handle, wherein a fastening clip having a passage opening is inserted through openings of the grab handle and the headliner. At the end of the passage opening, there is a short piece of internal threading, which accommodates the screw in the pre-assembly position. By means of the fastening clip, which is supported on the rear of the headliner, and the screw, the grab handle and the headliner are held together in the pre-assembly unit in the pre-assembly position. In order to accommodate the screw, a weld nut is provided on the vehicle frame or body-side mounted portion configured as the base part.

In this approach according to the prior art, however, the fact that, for the final assembly of the pre-assembly unit, an additional component is required as a third fastening element, which must be attached in a laborious separate work step, has proven to be disadvantageous. Due to the positionally fixed attachment of the weld nut, a tolerance-based deviation of the screw-on points on the pre-assembly unit on the body-side mounted portion cannot be compensated. Additional solutions for accommodating tolerances on the trim part must therefore be realized. The screw-on point on the vehicle frame must likewise be located in an accessible location, in which it is technically possible to attach the weld nut. In principle, with the bolting of a vehicle grab handle to the vehicle body that is currently still customary, the mounting effort is relatively large.

In light of the situation described above, the underlying problem of the present disclosure is to specify a fastening possibility for a vehicle component, in particular an interior component, to a body component, wherein the vehicle component, which is in particular a vehicle grab handle or an airbag, can be fastened to the body component in a particularly easy-to-implement manner, wherein fastening of the interior component to the body component with reduced play or preferably no play can be effectively achieved, even in case of different sheet thicknesses of the body component or in case of tolerance-based deviations.

### SUMMARY

The present disclosure relates generally to forming connection between vehicle components, substantially as illustrated by and described in connection with at least one of the figures, as set forth more completely in the claims. More specifically, the present disclosure relates to an optimized fastening possibility, in particular for fastening a vehicle grab handle or an airbag to a body-side mounted portion, in particular in the automotive sector. The body-side mounted portion is also referred to here as a “vehicle body component.” In particular, a lasting, high-quality connection between the vehicle component, for example the vehicle grab handle, and the vehicle body is to be achievable with as little mounting effort as possible.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates, schematically and in an isometric view, a first exemplary embodiment of the assembly according to the disclosure in its fixed state.

FIG. 2 illustrates, schematically and in an isometric view, the retaining element of the exemplary embodiment of the assembly according to the disclosure according to FIG. 1.

FIG. 3 illustrates, schematically and in an isometric view, the locking and/or blocking element of the exemplary embodiment of the assembly according to the disclosure according to FIG. 1.

FIG. 4 illustrates, schematically and in an isometric view, the connecting element of the exemplary embodiment of the assembly according to the disclosure according to FIG. 1.

FIG. 5 illustrates, schematically and in a bottom view, the exemplary embodiment of the assembly according to the disclosure according to FIG. 1 without the locking and/or blocking element.

FIG. 6 illustrates, schematically and in an isometric view, a second exemplary embodiment of the assembly according to the disclosure.

FIG. 7 illustrates, schematically and in an isometric view, the retaining element of the exemplary embodiment of the assembly according to the disclosure according to FIG. 6.

FIG. 8 illustrates, schematically and in an isometric view, the locking and/or blocking element of the exemplary embodiment of the assembly according to the disclosure according to FIG. 6.

FIG. 9 illustrates, schematically and in an isometric view, the connecting element of the exemplary embodiment of the assembly according to the disclosure according to FIG. 6.

FIG. 10 illustrates, schematically and in a bottom view, the exemplary embodiment of the assembly according to the disclosure according to FIG. 6, but without the locking and/or blocking element.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y,z), (x, y, z)}. In other words, “x, y, and/or z” means “one or more of x, y, and z.”

Specifically, a fastening possibility for a vehicle component is to be provided that allows for intuitive assembly. The fastening possibility is to be designed in particular as a retaining clip, which can be mounted in an easily implemented manner without the skill, experience and capability of the assembler being decisive. Disassembly should also be possible.

Moreover, the fastening assembly is designed to automatically allow for tolerance compensation between the vehicle component to be fastened and the body component or an opening embodied in the body component, respectively.

Accordingly, the present disclosure relates to an assembly for providing a fastening possibility for a vehicle component, in particular an interior component, to a body component, wherein the assembly is in particular designed as a torsion clip.

In structural terms, the assembly comprises a connecting element preferably made of a plastic material, with which the vehicle component, for example the door grab handle or an airbag component, can be connected.

The assembly further comprises a retaining element, preferably made of a plastic material, for retaining the connecting element on the body component.

The retaining element comprises a base body with a retaining region at a first end region of the base body. The connecting element furthermore comprises a base body with a receptacle opening, through which the retaining element can be received at least in some areas, or through which the retaining element and in particular the retaining region of the retaining element can be inserted at least in some areas in the insertion direction.

The solution according to the disclosure is in particular wherein the retaining element is rotatable in relation to the connecting element to assemble the assembly, wherein, when the retaining element is rotated in relation to the connecting element, a linear force acting on the retaining element is generated, so that the retaining element is tensioned against the connecting element.

This measure makes it possible, in a simple but effective manner, to effectively achieve fastening of the interior components with reduced play or preferably no play to the body component even with different sheet thicknesses or sheet thickness tolerances of the body component, or with tolerance-related deviations.

In a preferred realization of the assembly according to the disclosure, it is provided that the holding element comprises at least one clamping surface, which in the state of being connected to the connecting element interacts with a clamping surface of the connecting element in accordance with the lever principle or the principle of an oblique plane, such that when the holding element is rotated in relation to the connecting element, the force acting on the holding element, in particular linear force, is generated.

According to the present disclosure, it is in particular provided that the base body of the holding element is preferably designed with a rotationally symmetrical configuration at least in some areas. It is conceivable in this context, for example, that a crown region, which is in particular annular at least in some areas, is preferably formed on a second end region of the base body opposite the first end region, a fitted region preferably being formed between the crown region and the retaining region.

In this embodiment, the base body of the connecting element should preferably comprise a support surface, which is adapted to the geometry and/or size of the crown region at least in some areas, and on which the crown region of the holding element rests at least partially or in some areas.

In this context, it is convenient that the clamping surface is formed at least partially or in some areas by the support surface of the base body of the connecting element and/or at least partially or in some areas by the surface of the crown area of the retaining element facing the support surface of the base body of the connecting element.

According to a further aspect of the disclosure, for assembling the assembly with reduced or no play, it is provided that the retaining element and in particular the retaining region of the retaining element are associated with at least one, in particular wedge-shaped or ramp-shaped, clamping region and/or at least one, in particular helix-shaped, clamping region, which, when the retaining element is rotated in relation to the connecting element, is screwed into a region, in particular a region in the form of a gap, between the retaining element and in particular the retaining region of the retaining element and an edge region of the body component surrounding a fastening opening of the body component, in particular by exerting a lever action.

The assembly according to the disclosure is characterized in particular in that it can be transitioned from a pre-assembly or delivery state, in which the retaining region of the retaining element is not yet inserted through a fastening opening in the body component, i.e. a state in which the assembly is provided by the supplier, into a pre-fixation state, in which the retaining region of the retaining element is inserted through the fastening opening of the body component, and an edge region of the body component surrounding the fastening opening is received at least in some areas between the retaining region of the retaining element and the base body of the connecting element.

In order to transition the assembly from its pre-assembly or delivery state into its pre-fixation state, a torque is exerted on at least the retaining region of the retaining element such that, starting from a basic state, at least the retaining region of the retaining element is rotated in relation to the connecting element and in relation to the fastening opening of the body component in order to allow a passage of the retaining region through the fastening opening of the body component.

After the passage of the retaining element through the fastening opening of the body component, the torque previously exerted on the retaining region is at least partially lifted and the retaining region is again in its basic state.

The assembly according to the disclosure is thus characterized in that, for the mounting of the assembly on the body component, it has only to be inserted into the fastening opening of the body component. The assembly is transitioned from its pre-assembly or delivery state “automatically” into its pre-fixation state. The assembly can thus be mounted to the body component with simple movements by hand. In particular, no tools are required for this purpose.

Moreover, because the assembly is provided in its pre-assembly or delivery state by the supplier, it is not necessary to properly put together the individual components of the assembly during final mounting.

Overall, a simplified mounting of the assembly, which is embodied in particular as a torsion clip, is thus possible.

According to realizations of the present disclosure, it is provided that the retaining element can be rotated in relation to the connecting element about an axis of rotation extending in the insertion direction of the retaining element, namely: from a first rotational position of the retaining element, in which the retaining element is connectable to the connecting element for putting together the assembly, into a second rotational position of the retaining element, in which the retaining element is connected to the connecting element and the assembly is in its pre-assembly or delivery state or in its pre-fixation state; and from the second rotational position of the retaining element into a third rotational position of the retaining element, in which the retaining element is located when the retaining region passes through the fastening opening of the body component.

The assembly according to this aspect of the disclosure can furthermore be transitioned from its pre-fixation state to a fixed state, in which the retaining portion of the retaining element inserted through the fastening opening of the body component exerts a force acting against the direction of insertion, at least partially or in some areas, on the edge region of the body component surrounding the fastening opening, so as to fix the connecting element to the body component.

In order to transition the assembly from its pre-fixation state into its fixed state, according to embodiments of the disclosure, the retaining element is further rotated in relation to the connecting element from its rotational position into a fourth rotational position.

In order to ensure that, even in the case of different sheet thicknesses of the body component and/or tolerance-based deviations, the assembly or connecting element of the assembly is fastened on the body component with reduced play or preferably no play to the greatest extent possible, it is provided according to embodiments of the disclosure that the retaining element, and in particular the retaining region of the retaining element, is associated with at least one in particular wedge-shaped or ramp-shaped clamping region, which, when the assembly is transitioned into its fixed state, and in particular when the retaining element is rotated from its second rotational position into its fourth rotational position, is rotated into an in particular gap-shaped region between the retaining element, in particular the retaining region of the retaining element, and the edge region of the body component surrounding the fastening opening of the body component, in particular by exerting a leverage effect.

Here, it is preferably provided that the base body of the connecting element preferably comprises a base region, which is adapted preferably at least regionally to the size and/or geometry of the fastening opening of the body component, and which is accommodated at least regionally in the fastening opening of the body component in the pre-fixation state and in the fixed state of the assembly.

In this context, it is provided in particular that the base region is preferably designed to be elastically deformable at least regionally in the insertion direction or comprises corresponding regions that are elastically deformable at least regionally in the insertion direction. This is meant to ensure that the base region or the elastically deformable region of the base region is elastically deformed or deformable at least at least partially or in some areas when the in particular wedge-shaped or ramp-shaped clamping region is rotated in due to the leverage effect exerted thereby. This provides an easy-to-implement, but nonetheless simple possibility for fastening the connecting element to the body component without play in case of different sheet thicknesses and/or tolerance-based deviations.

According to implementations of the assembly according to the disclosure, it is preferably provided that the connecting element comprises alignment means for aligning the connecting element and the retaining element inserted into the opening of the base body of the connecting element in relation to the fastening opening of the body component. The alignment means are in particular designed in order to realize an alignment of the connecting element in relation to the fastening opening of the body component according to the poka-yoke principle.

In this context, it is conceivable, for example, that the retaining region of the retaining element has a geometry, in particular cross-sectional geometry, and/or size, that is adjusted with respect to the fastening opening of the body component such that, in the state of being aligned with respect to the fastening opening of the body component, the retaining region of the retaining element is only insertable in its state of being rotated out of the basic state through the fastening opening of the body component.

In this context, it is conceivable that the retaining region of the retaining element preferably comprises at least one in particular outer-peripheral guiding surface, which is configured in order to generate a torque for rotating the retaining region out of its basic state when transitioning the assembly from its pre-assembly or delivery state into its pre-fixation state and when the retaining region is inserted into the fastening opening of the body component in the insertion direction in relation to the body component.

In a further development of the assembly according to the disclosure, it is provided that the assembly furthermore comprises a locking and/or blocking element that is preferably made of a plastic material for fixing a position and/or orientation of the retaining element in relation to the connecting element.

The locking and/or blocking element comprises a land region extending in the insertion direction, wherein the land region preferably comprises two opposing finger and/or wing elements that radially project from the land region. On the other hand, the base body of the retaining element comprises a passage extending in the longitudinal direction of the base body or a recess extending in the longitudinal direction of the base body, in which passage or recess the land region of the locking and/or blocking element with the finger or wing elements projecting from the land region can be received or is received, at least in part or in some areas. The passage or recess of the base body of the retaining element comprises a first guide system which is designed to guide the finger or wing elements of the locking and/or blocking element when inserting the land region into the passage or recess of the base body of the retaining element.

In addition, the passage or recess of the base body of the holding element comprises a (further) second guide system, which is formed to guide the finger or wing elements of the locking and/or blocking element out of the passage or out of the recess of the base body of the holding element when the land region is guided out.

This special construction of the locking and/or blocking element allows for fixation of the retaining element in its mounted state. Herein the finger or wing elements projecting from the land region are present in the first guide system. To disassemble the assembly or disassemble the retaining element, the finger or wing elements of the locking and/or blocking element are transitioned into the second guide system.

According to preferred implementations of the assembly according to the disclosure, it is provided that the first guide system comprises two interior groove regions opposite to one another and embodied in the inner wall of the passage or in the inner wall of the recess of the base body of the holding element, in which at least one of the two finger or wing elements of the locking and/or blocking element is receivable, respectively.

Alternatively or additionally, it is conceivable that the second guide system also comprises two inner groove regions which are opposite to one another and formed in the inner wall of the passage or recess of the base body of the retaining element, and in each of which one of the two finger or wing elements of the locking and/or blocking element can be received at least partially or in some areas.

Preferably, the first guide system comprises a first region and a second region connected to the first region via a projection provided in the first guide system. The first and second regions, as well as the projection of the first guide system, are arranged so as to that upon insertion of the land region into the passage or recess of the base body of the holding element, the two finger or wing elements of the locking and/or blocking element first follow the guide of the first region of the first guide system, wherein, in order to transition to the second region of the first guide system, the finger or wing elements of the locking and/or blocking element must be moved radially inwardly with respect to the land region.

In a conceivable realization of the last-mentioned embodiment, it is provided that the land region, in particular in the region of the two finger or wing elements, is formed elastically such that—at least over a predefined or definable distance—which is in particular sufficient to overcome the projection between the first and second region of the first guide system—the two finger or wing elements can move towards each other in a radial direction, as viewed in relation to the direction of extension of the land region.

The second guide system, on the other hand, is preferably arranged without a projection in one of the inner groove regions.

To elastically form the land region, the land region can comprise a window region, in particular in the region of the two finger or wing elements.

The first guide system of the passage or recess of the base body of the holding element is connected to the second guide system of the passage or recess of the base body of the holding element via a bevel that is inclined towards the inner groove regions of the second guide system in particular, via which, upon transitioning the finger or wing elements of the locking and/or blocking element from the first guide system to the second guide system, the finger or wing elements of the locking and/or blocking element are guided during simultaneous torsion of the land region of the locking and/or blocking element.

The locking and/or blocking element should preferably comprise at least one latching means for preferably releasably latching the locking and/or blocking element, at least in its second state.

As already stated, the assembly according to the disclosure can preferably be transitioned from its pre-fixation state into a fixed state, in which the retaining region of the retaining element inserted through the fastening opening of the body component exerts a force, which acts on the edge region of the body component surrounding the fastening opening at least regionally counter to the insertion direction, in order to fix the connecting element to the body component.

In this context, it is preferably provided that when transitioning the assembly from its pre-fixation state to its fixed state as well as in the fixed state of the assembly, the finger or wing elements of the locking and/or blocking element overcome the protrusion provided in the first guide system and transition to the second area of the first guide system.

The assembly according to the first and second aspects of the present disclosure is preferably formed entirely from a plastic material.

It is characterized by its constructively simple manufacture and can be achieved, for example, by a common injection molded process for the retaining element and/or the connecting element.

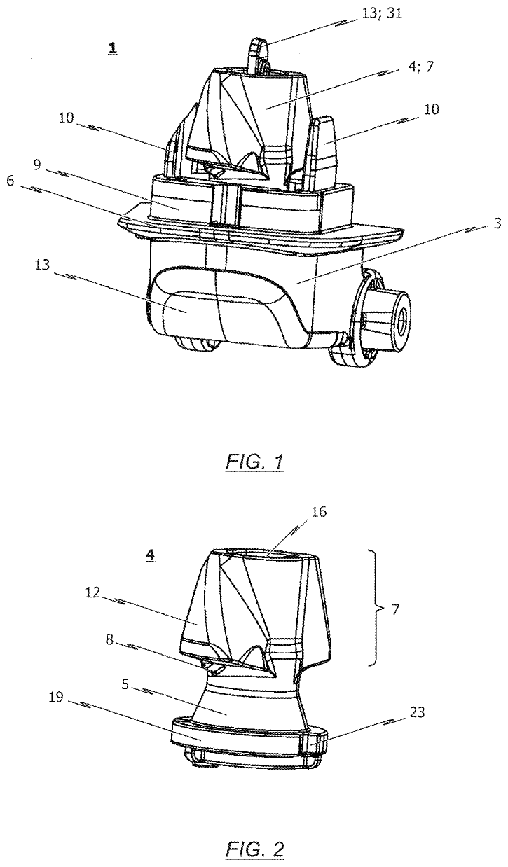

Referring to the illustrations in FIG. 1 to FIG. 5, a first preferred embodiment of the fastening assembly according to the disclosure is described in further detail below.

While the exemplary embodiments of the fastening assemblies 1 shown in the drawings are shown in connection with a grab handle, the use of the fastening assembly 1 is not limited to this application. Rather, the fastening assembly 1 according to the disclosure is suitable for providing a fastening possibility for any vehicle component, in particular an interior component, to a body component. An example in this regard is fastening, for example, of airbags or other interior components, in particular.

The body component is preferably a sheet metal part. Again, this is not to be construed as limiting. Other body components, in particular interior skin components of the vehicle, can be considered.

The fastening assembly 1 according to the disclosure is characterized in particular in that all components of the assembly 1 are formed from a plastic material. The individual components of the fastening assembly 1 are in particular designed as plastic injection molded parts.

The fastening assembly 1 can in particular be mounted without tools, wherein the fastening assembly 1 is delivered to the vehicle manufacturer in a pre-assembly or delivery state.

In order to mount the fastening assembly 1, it is insertable into a fastening opening of the body component, wherein, during the insertion operation, the fastening assembly 1 first self-transitions from its pre-assembly or delivery state into a pre-fixation state, and can then be transitioned into a fixed state. Herein the fastening assembly 1 is sequentially transitioned in one movement by hand during mounting in or on the body component from the pre-assembly or delivery state into the pre-fixation state, and then into the final fixed state.

In the process, the assembly 1 automatically/independently performs a tolerance compensation. This allows the fastening assembly 1 to also be usable for different sheet thicknesses of the body component, for example. Also, the fastening assembly 1 automatically balances tolerance deviations in the size and/or shape of the fastening opening formed in the body component.

After mounting the fastening assembly 1, it can be released from the fixed state again by manipulation with a tool, in particular with a screwdriver.

The fastening assembly 1 substantially comprises a connecting element 3, which—as already stated—is preferably embodied as a plastic part, in particular an injection molded part. The connecting element 3 serves to provide a connection to the vehicle component to be fastened, for example an interior grab handle.

In addition to the connecting element 3, the fastening assembly 1 comprises a retaining element 4, which is also preferably made of a plastic material, and in particular a plastic injection molded part. The retaining element 4 serves to hold the connecting element 3, to which the vehicle component is connectable, to the body component.

The retaining element 4 substantially comprises a base body 5, which in turn comprises a retaining region 7 at a first end region of the base body 5.

The connecting element 3 likewise comprises a base body 6 with a receptacle opening 11, in which or through which the retaining element 4, and in particular the retaining region 7 of the retaining element 4, is at least regionally receivable/insertable.

As already stated, the assembly 1 can be transitioned from a pre-assembly or delivery state into a pre-fixation state. In the pre-assembly or delivery state of the assembly 1, the retaining region 7 of the retaining element 4 is not yet inserted through the fastening opening in the body component.

In the pre-fixation state of the assembly 1, on the other hand, the retaining region 7 of the retaining element 4 is already inserted through the fastening opening of the body component, and an edge region surrounding the fastening opening of the body component is at least in some areas accommodated between the retaining region 7 of the retaining element 4 and the base body 6 of the connecting element 3.

Herein it is expedient for a fitted region to be formed between the first end region of the base body 5, at which the retaining region 7 of the retaining element 4 is formed, and the opposite second end region of the base body 5, which fitted region is arranged radially adjacent to the edge region surrounding the fastening opening of the body component in the pre-fixation state of the assembly 1.

According to embodiments of the fastening assembly 1 according to the disclosure, the base body 5 of the retaining element 4 is preferably designed to be rotationally symmetrical at least in some areas.

It can further be seen in the exemplary embodiments of the assembly 1 according to the disclosure, shown schematically in the drawings, that a crown region 19, designed in particular to be at least regionally annular, is formed at a second end region of the base body 5 lying opposite the first end region of the base body 5 of the retaining element 4, wherein the aforementioned fitted region is formed between the crown region 19 and the retaining region 7.

When transitioning the assembly 1 from its pre-assembly or delivery state into its pre-fixation state, a torque is exerted on at least the retaining region 7 of the retaining element 4 such that, starting from a basic state of the retaining region 7, at least the retaining region 7 of the retaining element 4 is rotated in relation to the connecting element 3 and in relation to the fastening opening of the body component in order to allow passage of the retaining region 7 through the fastening opening of the body component.

After the passage of the retaining element 4 or retaining region 7 of the retaining element 4 through the fastening opening of the body component, the torque previously exerted on the retaining region 7 is at least partially nullified, and the retaining region 7 is again in its basic state, i.e. in the rotational position in relation to the connecting element 3 and in relation to the fastening opening of the body component, in which the retaining region 7 is in the pre-assembly or delivery state of the assembly 1, i.e. before the retaining region 7 of the retaining element 4 has been inserted through the fastening opening of the body component.

In other words, the fastening assembly 1 is designed such that the retaining element 4, in particular the retaining region 7 of the retaining element 4, can be rotated in relation to the connecting element 3 of the assembly 1 around an axis of rotation extending in the insertion direction of the retaining element 4.

In particular, the retaining element 4 and in particular the retaining region 7 of the retaining element 4, can be rotated in relation to the connecting element 3 of the assembly 1 around an axis of rotation extending in the insertion direction of the retaining element 4 from a first rotational position of the retaining element 4 or retaining region 7 of the retaining element 4, in which position the retaining element 4 is connectable to the connecting element 3 for assembling the assembly 1 (assembled state), into a second rotational position of the retaining element 4 or retaining region 7 of the retaining element 4, in which the retaining element 4 is connected to the connecting element 3, and in which the assembly 1 is in its pre-assembly or delivery state.

The second rotational position of the retaining region 7 of the retaining element 4 preferably corresponds to the aforementioned basic state of the retaining region 7, i.e. the rotational position of the retaining region 7 in relation to the connecting element 3 and in relation to the fastening opening of the body component in the pre-assembly or delivery state of the assembly 1.

The second rotational position of the retaining region 7 of the retaining element 4 is preferably also present when the assembly 1 is in its pre-fixation state.

In other words, in order to assemble the assembly 1 and transition the assembly 1 into its pre-assembly or delivery state, the retaining element 4 is mounted to the connecting element 3 with the retaining region 7, namely by inserting the retaining element 4 onto the connecting element 3 and transitioning it from the first rotational position into the second rotational position in relation to the connecting element 3 in order to fasten the retaining element 4 onto the connecting element 3 (=assembled state).

After the assembly of the retaining element 4 onto the connecting element 3, as a result of which the retaining element 4 is transitioned from the first rotational position into the second rotational position in relation to the connecting element 3, the assembly 1 is in the aforementioned pre-assembly or delivery state, in which the retaining element 4 is temporarily fastened to the connecting element 3.

In the pre-assembly or delivery state, the assembly 1 is thus present as a (single) component consisting of the connecting element 3 and the retaining element 4 fastened thereto.

According to embodiments of the assembly 1 according to the disclosure, it is further provided that the retaining element 4 or retaining region 7 of the retaining element 4 can be further transitioned from the second rotational position into a third rotational position around the rotational axis extending in the insertion direction of the retaining element.

The retaining element 4 or retaining region 7 of the retaining element 4 is in the third rotational position when the retaining region 7 is inserted through the fastening opening of the body component while transitioning the assembly from its pre-assembly or delivery state into its pre-fixation state.

According to design variants of the assembly 1 according to the disclosure, the assembly can furthermore be transitioned from its pre-fixation state into a fixed state, in which the retaining region 7 of the retaining element 4 inserted through the fastening opening of the body component exerts a force, which acts on the edge region of the body component surrounding the fastening opening at least in some areas against the insertion direction, in order to fix the connecting element 3 to the body component.

In particular, it is provided herein that, when the assembly 1 is in its pre-fixation state, i.e. when the retaining region 7 of the retaining element 4 is already inserted through the fastening opening of the body component and an edge region of the body component surrounding the fastening opening is received at least in some areas between the retaining region 7 of the retaining element 4 and the base body 6 of the connecting element 3, the assembly 1 is still movable in relation to the body component. For fixation of the assembly 1 without play, it is provided that the assembly 1 can be transitioned from its pre-fixation state into the fixed state.

In this context, it is conceivable that the retaining element 4 or retaining region 7 of the retaining element 4 can further be rotated in relation to the connecting element 3 around the rotational axis extending in the insertion direction of the retaining element 4, namely from the second rotational position, in which the retaining element 4 or retaining region 7 of the retaining element 4 is in the pre-fixation state, into a fourth rotational position.

According to design variants of the assembly 1 according to the disclosure, the assembly can furthermore be transitioned from its pre-fixation state into a fixed state, in which the retaining region 7 of the retaining element 4 inserted through the fastening opening of the body component exerts a force, which acts on the edge region of the body component surrounding the fastening opening at least in some areas against the insertion direction, in order to fix the connecting element 3 to the body component.

In particular, it is provided herein that, when the assembly 1 is in its pre-fixation state, i.e. when the retaining region 7 of the retaining element 4 is already inserted through the fastening opening of the body component and an edge region of the body component surrounding the fastening opening is received at least in some areas between the retaining region 7 of the retaining element 4 and the base body 6 of the connecting element 3, the assembly 1 is still movable in relation to the body component. For fixation of the assembly 1 without play, it is provided that the assembly 1 can be transitioned from its pre-fixation state into the fixed state.

In this context, it is conceivable that the retaining element 4 or retaining region 7 of the retaining element 4 can further be rotated in relation to the connecting element 3 around the rotational axis extending in the insertion direction of the retaining element 4, namely from the second rotational position, in which the retaining element 4 or retaining region 7 of the retaining element 4 is in the pre-fixation state, into a fourth rotational position.

By further rotating the retaining region 7 of the retaining element 4 in relation to the connecting element 3, a force acting in the insertion direction is generated according to the leverage principle, thereby tensioning the retaining element 4 against the connecting element 3, causing a Z-axis compensation. Herein the Z-axis refers to the insertion direction of the assembly 1.

For example, it is conceivable that the retaining element 4, in particular the retaining region 7 of the retaining element 4, is associated with at least one, in particular wedge-shaped or ramp-shaped, clamping region 8, which, when the assembly 1 is transitioned into its fixed state, and in particular when the retaining element 4 is rotated from its second rotational position into its fourth rotational position, is rotated into a region, in particular in the form of a gap, between the retaining element 4 and in particular the retaining region 7 of the retaining element 4, and the edge region of the body component surrounding the fastening opening of the body component, namely by exerting a leverage effect.

On the other hand, the base body 6 of the connecting element 3 preferably comprises a base region 9 which is preferably adapted at least in some areas to the size and/or geometry of the fastening opening of the body component, and which is accommodated at least in some areas in the fastening opening of the body component in the pre-fixation state and in the fixed state of the assembly 1.

In this context, it is advantageous in particular that the base region 9 is preferably designed to be elastically deformable at least in some areas in the insertion direction, in particular such that, when the in particular wedge-shaped or ramp-shaped clamping region 8 is twisted in, it is elastically deformed or deformable at least partially or in some areas due to the leverage effect exerted thereby.

As stated, the fastening assembly 1 according to the disclosure is characterized in particular by the fact that, during the mounting of the fastening assembly 1 on a body component, the retaining element 4, in particular the retaining region 7 of the retaining element 4, is rotated in relation to the connecting element 3, thereby enabling the passage of the retaining region 7 of the retaining element 4 through the fastening opening of the body component in the first place.

After the retaining region 7 of the retaining element 4 has passed through the fastening opening, the retaining region 7 of the retaining element 4 skips back again.

A further rotating of the retaining region 7 in relation to the connecting element 3 then—while exerting a leverage effect—tensions the retaining element 4 in relation to the connecting element 3 and the body component that is received between the retaining element 4 and the connecting element 3.

In order to be able to bring about this desired rotational movement of the retaining element 4 and in particular of the retaining region 7 of the retaining element 4 in relation to the connection element 3 while assembling the assembly 1, the retaining region 7 of the retaining element 4 is preferably formed slightly conically and tapering in the direction of insertion, the retaining region 7 of the retaining element 4 preferably comprising a plurality of guide surfaces 12, in particular on the outer circumference, which are designed to generate a torque when the assembly 1 is transferred from its pre-assembly or delivery state to its pre-fixing state, and when the retaining region 7 is inserted into the fastening opening of the body component in the insertion direction in relation to the body component, which torque leads to the rotation of the retaining region 7 from its basic state.

As indicated in the drawings, the outer circumferential guide surfaces 12 of the retaining region 7 are preferably helix-shaped so as to generate a corresponding torque when the retaining region 7 is inserted into the fastening opening for rotating the retaining region 7.

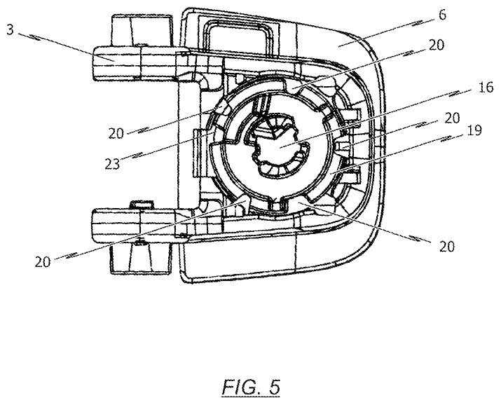

In particular, it can be seen from the illustration in FIG. 4 that the connecting element 3 preferably comprises at least one alignment means 10 in the form of a projection, which serves to align the connecting element 3 and in particular the base body 6 of the connecting element 3 in relation to the fastening opening, and to position it accordingly. Herein the alignment means 10 of the connecting element 3 is in particular guided through a corresponding (further) opening in the body component, and thus serves to pre-fix/pre-position the base body 6 of the connecting element 3.

The retaining region 7 of the retaining element 4 preferably comprises a geometry, in particular a cross-sectional geometry, and/or size that is adapted with respect to the fastening opening of the body component such that, in the state of being aligned with respect to the fastening opening of the body component, the retaining region 7 of the retaining element 4 can be inserted through the fastening opening of the body component only in the state wherein it is rotated from the basic state.

According to embodiments of the fastening assembly 1 according to the disclosure, it is provided that it further comprises a locking and/or blocking element 13, which is also preferably formed from a plastic material, in particular in the course of a plastic injection molded process.

The locking and/or blocking element 13 in particular serves to determine a location and/or position of the retaining element 4 in relation to the connecting element 3.

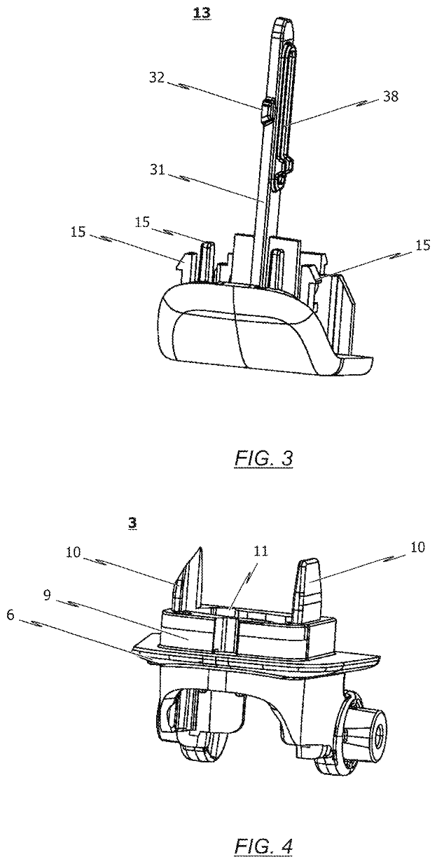

As can be seen, for example, from the illustration in FIG. 3, the locking and/or blocking element 13 comprises a land region 31 extending in the insertion direction, wherein the land region 31 preferably comprises two opposing finger and/or wing elements 32 that radially project from the land region 31.

On the other hand, the base body 5 of the retaining element 4 comprises a passage 16 extending in the longitudinal direction of the base body 5, in which the land region 31 of the locking and/or blocking element 13 with the finger or wing elements 32 projecting from the land region 31 is received or receivable at least partially or in some areas.

The passage 16 of the base body 5 of the holding element 4 preferably comprises a first guide system, which is configured to guide the finger or wing elements 32 of the locking and/or blocking element 13 when inserting the land region 31 into the passage 16 of the base body 5 of the holding element 4.

Furthermore, the passage 16 of the base body 5 of the holding element 4 comprises a second guide system, which is formed to guide the finger or wing elements 32 of the locking and/or blocking element 13 when the land region 31 is guided out of the passage 16 of the base body 5 of the holding element 4.

In order to be able to implement an elasticity of the land region 31, it is provided in the embodiment shown in the drawings that the land region 31 comprises a window region 38, particularly in the area of the two finger or wing elements 32.

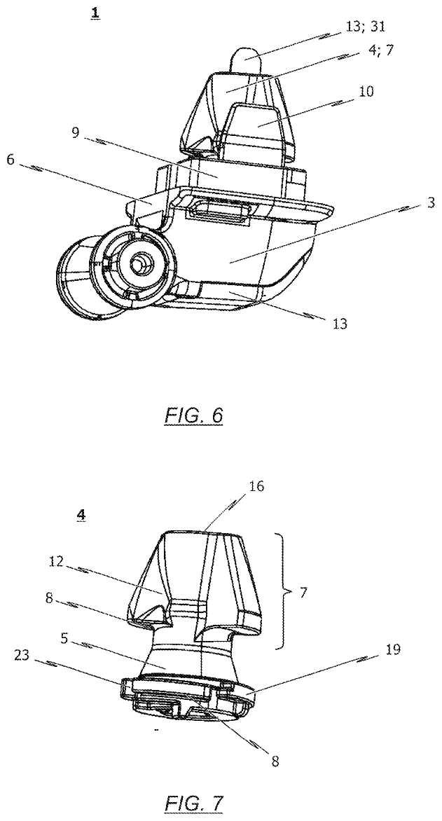

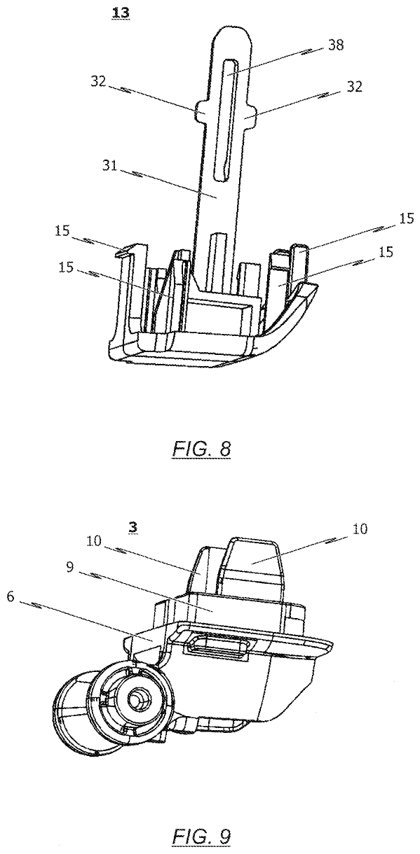

The second exemplary embodiment of the fastening assembly 1 according to the disclosure as shown in FIG. 6 to FIG. 10 substantially corresponds to the first exemplary embodiment of the fastening assembly 1 previously described with reference to the illustrations of FIG. 1 to FIG. 5.

However, in the second exemplary embodiment, a further (additional) clamping surface (clamping area 8) is provided in order to generate a force acting on the holding element 4, in particular a linear force, when the holding element 4 is rotated in relation to the connecting element 3, so that the holding element 4 is tensioned against the connecting element 3.

In detail, and as can be seen in particular, for example, from the illustration in FIG. 7, in the second exemplary embodiment of the fastening assembly 1 according to the disclosure, it is provided that the base body 5 of the retaining element 4 is preferably designed to be rotationally symmetrical at least in some areas, wherein a crown region 19 which is designed in particular to be annular at least in some areas is preferably formed on a second end region of the base body 5 opposite the first end region. A fitted area is formed between the crown region 19 and the holding region 7.

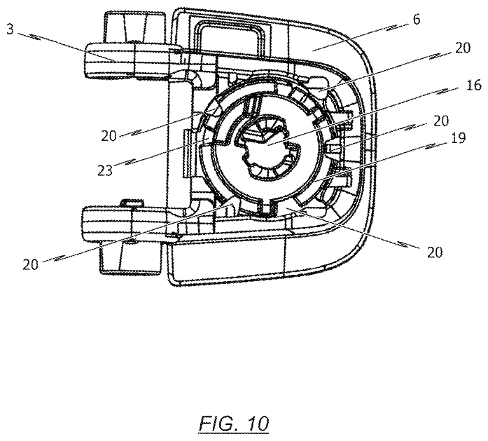

On the other hand, as can be seen from the view according to FIG. 10, the base body 6 of the connecting element 3 has a support surface 20, which is adapted at least in some areas to the geometry and/or size of the crown region 19, on which the crown region 19 of the holding element 4 rests at least partially or in some areas.

In this embodiment, it is provided that the clamping surface (clamping area 8) is formed at least partially or in some areas by the support surface 20 of the base body 6 of the connecting element 3 and/or at least partially or in some areas by the surface of the crown region 19 of the holding element 4 that faces the support surface 20 of the base body 6 of the connecting element 3.

In detail, and as can be taken from the isometric view according to FIG. 7, the individual portions of the crown region 19 of the holding element 4 are designed in a ramp shape, so that the holding element 4 is tensioned against the connecting element 3 when the holding element 4 is rotated in relation to the connecting element 3.

The disclosure is not limited to the exemplary embodiments shown in the drawings, but results when all of the features disclosed herein are considered together.

What is claimed is:

1. An assembly (1) for providing a fastening possibility for a vehicle component (2), in particular an interior component, to a body component, wherein the assembly (1) is in particular embodied as a torsion clip, and comprises the following:
a connecting element (3) to which the vehicle component (2) is connectable; and
a retaining element (4) for retaining the connecting element (3) on the body component,
wherein
the retaining element (4) comprises a base body (5) with a retaining region (7) at a first end region of the base body (5), and the connecting element (3) comprises a base body (6) with a receptacle opening (11) in which the retaining element (4) is receivable at least in some areas, or through which the retaining element (4), and in particular the retaining region (7) of the retaining element (4), is insertable at least in some areas,
wherein the retaining element (4) can be rotated in relation to the connecting element (3) and wherein, when the retaining element (4) is rotated in relation to the connecting element (3), a force acting on the retaining element (4), in particular a linear force, is generated so that the retaining element (4) is tensioned against the connecting element (3).

2. The assembly (1) according to claim 1,
wherein the retaining element (4) comprises at least one clamping surface, which, in the state of being connected to the connecting element (3), interacts with a clamping surface of the connecting element (3) according to a leverage principle or according to a principle of the oblique plane, such that when the retaining element (4) is rotated in relation to the connecting element (3), the force acting on the retaining element (4), in particular a linear force, is generated.

3. The assembly (1) according to claim 1,
wherein the base body (5) of the retaining element (4) is arranged in a rotationally symmetrical manner at least in some areas, wherein a crown region (19), designed in particular to be annular at least in some areas, is formed at a second end region of the base body (5) opposite the first end region, and wherein a fitted region is formed between the crown region (19) and the retaining region (4),
wherein the base body (6) of the connecting element (3) comprises a support surface (20) that is adapted to a geometry or size of the crown region (19) at least in some areas, on which the crown region (19) of the holding element (4) rests at least partially or in some areas.

4. The assembly (1) according to claim 3,
wherein the clamping surface is formed at least partially or in some areas by the support surface of the base body (6) of the connecting element (3) or at least partially or in some areas by the surface facing the support surface (20) of the base body (6) of the connecting element (3) of the crown region (19) of the holding element (4).

5. The assembly (1) according to claim 1,
wherein the retaining element (4) and in particular the retaining region (7) of the retaining element (4) are associated with at least one, in particular wedge-shaped or ramp-shaped, clamping region (8) or at least one, in particular helix-shaped, clamping region (8), which, when the retaining element (4) is rotated in relation to the connecting element (3), is screwed into a region, in particular a gap-shaped region, between the retaining element (4) and in particular the retaining region (7) of the retaining element (4) and an edge region of the body component surrounding a fastening opening of the body component, in particular by exerting a leverage action.

6. The assembly (1) according to claim 1,
wherein the retaining element (4) or retaining region (7) of the retaining element (4) can be rotated in relation to the connecting element (3) around a rotational axis extending in particular in the insertion direction of the retaining element (4), namely:
from a first rotational position of the retaining element (4) or retaining region (7) of the retaining element (4), in which the retaining element (4) is connectable to the connecting element (3) for assembling the assembly (1), into a second rotational position of the retaining element (4) or retaining region (7) of the retaining element (4), in which the retaining element (4) is connected to the connecting element (3) and the assembly (1) is in its pre-assembly or delivery state or in its pre-fixation state; and
from the second rotational position of the retaining element (4) or retaining region (7) of the retaining element (4) into a third rotational position of the retaining element (4) or retaining region (7) of the retaining element (4), in which the retaining element (4) is located when the retaining region (7) passes through the fastening opening of the body component.

7. The assembly (1) according to claim 6,
wherein the assembly (1) can furthermore be transitioned from its pre-fixation state into a fixed state, in which the retaining region (7) of the retaining element (4) that is inserted through the fastening opening of the body component exerts a force, which acts on an edge region of the body component surrounding the fastening opening against the insertion direction at least in some areas, in order to fix the connecting element (3) to the body component.

8. The assembly (1) according to claim 6,
wherein, in order to transition the assembly (1) from its pre-fixation state into its fixed state, the retaining element (4) or retaining region (7) of the retaining element (4) is further rotated from its second rotational position in relation to the connecting element (3) into a fourth rotational position.

9. The assembly (1) according to claim 8,
wherein the retaining element (4), and in particular the retaining region (7) of the retaining element (4), is associated with at least one, in particular wedge-shaped or ramp-shaped, clamping region (8) or at least one, in particular helix-shaped, clamping region (8), which, when the assembly (1) is transitioned into its fixed state, and in particular when the retaining element (4) is rotated from its second rotational position into its fourth rotational position, is rotated into a region, in particular a gap-shaped region, between the retaining element (4), in particular the retaining region (7) of the retaining element (4), and the edge region of the body component surrounding the fastening opening of the body component, in particular by exerting a leverage effect.

10. The assembly (1) according to claim 9,
wherein the base body (6) of the connecting element (3) comprises a base region (9) that is adapted at least in some areas to the size or geometry of the fastening opening of the body component, which base region is received at least in some areas in the fastening opening of the body component in the pre-fixation state and in the fixed state of the assembly (1), wherein the base region (9) is designed to be elastically deformable at least in some areas in the insertion direction, in particular such that, when the in particular wedge-shaped or ramp-shaped clamping region (8) is twisted in, it is elastically deformed or deformable at least partially or in some areas due to the leverage effect exerted thereby.

11. The assembly (1) according to claim 3,
wherein the support surface (20) of the base body (6) of the connecting element (3) is adapted at least in some areas to the geometry or size of the edge region (19), such that, at least in a pre-assembly or delivery state of the assembly (1) and further in a pre-fixation state of the assembly (1), the edge region (19) of the retaining element (4) rests at least in some areas on the support surface (20) of the connecting element (3).

12. The assembly (1) according to claim 11,
wherein at least one recess (23) is formed in the crown region (19) of the retaining element (4), and wherein the connecting element (3) comprises a region (26) designed to be complementary at least in some areas to the at least one recess (23) of the crown region (19) and protruding in the direction of the receptacle opening (11) of the connecting element (3), which region is formed such that, in the first rotational position of the retaining element (4) and only in the first rotational position of the retaining element (4), the retaining element (4) is connectable to the connecting element (3), such that the crown region (19) of the retaining element (4) rests on the support surface (20) of the connecting element (3) at least in some areas,
wherein the at least one region (26) protruding in the direction of the receptacle opening (11) of the connecting element (3) is arranged so that it is offset from the plane in which the crown region (19) of the retaining element (4) is located, such that the at least one region (26) protruding in the direction of the receptacle opening (11) of the connecting element (3) blocks a release of the connection between the retaining element (4) and the connecting element (3) in the second rotational position of the retaining element (4).

13. The assembly (1) according to claim 1,
wherein the assembly (1) further comprises a locking or blocking element (13) for establishing a location or position of the retaining element (4) in relation to the connecting element (3),

14. The assembly (1) according to claim 1,
Wherein the retaining element (4) comprises a base body (5) with a retaining region (7) at a first end region of the base body (5), and the connecting element (3) comprises a base body (6) with a receptacle opening (11) through which the retaining element (4), and in particular the retaining region (7) of the retaining element (4), is insertable at least regionally, or
wherein the assembly (1) can be transitioned from a pre-assembly state, in which the retaining region (7) of the retaining element (4) is insertable or inserted through a fastening opening in the body component, into a fixed state, in which the retaining region (7) of the retaining element (4) inserted through the fastening opening of the body component exerts a force, which acts on the edge region of the body component surrounding the fastening opening against the insertion direction at least in some areas, in order to fix the connecting element (3) to the body component, or
wherein the assembly (1) further comprises a locking or blocking element (13) for establishing a location or position of the retaining element (4) in relation to the connecting element (3),
wherein the locking or blocking element (13) can be transitioned from a first state, in which the assembly (1) is in its pre-assembly state, into a second state, in which the assembly (1) is in its fixed state.
wherein the assembly (1) comprises at least one element formed, when the locking or blocking element (13) is transitioned from its first state into its second state, in order to translate a movement, in particular a linear movement, of the locking or blocking element (13) in relation to the connecting element (3) into a rotational movement of the retaining element (4) in relation to the connecting element (3) in order to transition the assembly (1) into its fixed state.
